(19) United States
(12) Patent Application Publication
(10) Pub. No.: US 2017/0034770 A1
(43) Pub. Date: Feb. 2, 2017

(54) METHOD AND SYSTEM FOR VALIDATING A CONNECTION BETWEEN DEVICES

(71) Applicant: Munish Sikka, Aldie, VA (US)

(72) Inventor: Munish Sikka, Aldie, VA (US)

(21) Appl. No.: 15/224,859

(22) Filed: Aug. 1, 2016

Related U.S. Application Data
(60) Provisional application No. 62/198,710, filed on Jul. 30, 2015.

(51) Int. Cl. H04W 48/14; H04W 72/04; H04W 4/02; H04W 76/02; H04B 1/3827

(52) U.S. Cl. CPC H04W 48/14; H04W 76/023; H04B 1/385; H04W 4/026; H04W 72/048

(57) ABSTRACT

The present disclosure validates pairs of electronic devices such as cell phones or smart watches which wish to exchange information. Its purpose is to provide a technique for transferring information from one electronic device to the other in a quick, safe and reliable way. In an embodiment, it provides identification and validation of discrete pairs of devices where there are other pairs of devices also trying to connect at the same time. It effectively reduces the risk of cross connections between these devices i.e. there no unintended pairs of devices which are connected or validated in such a case

### FIELD

The present disclosure generally is directed towards connecting devices and more specifically relates to a method and system for validating a discrete pair of devices for exchanging information

### BACKGROUND

Presently several technologies exist to validate a connection between electronic devices such as US20110191823 which describes Google's Bump validation. However the drawback in this technology is that it relies on close proximity and complicated gestures that are inconvenient to enact in certain situations and are also difficult to learn and memorise

WO2015/094220 describes validating a connection between devices for exchanging information using greeting gestures. However this method also requires close proximity between the devices

Apple's AirDrop is another service that connects devices for transferring data. Prior to an actual connection, it requires that the users communicate the names of their devices to other users with whom they are trying to connect. It also requires a 10 m proximity between the devices

All current technologies require that the devices are within a radius or a range from one another. These methods also have the risk of cross connections between devices which do not intend to connect. They are fairly complicated requiring gestures for various commands and are also time consuming requiring explicit authorization beforehand

### SUMMARY

The present disclosure validates pairs of electronic devices such as cell phones or smart watches which wish to exchange information. Its purpose is to provide a technique for transferring information from one electronic device to the other in a quick, safe and reliable way. In an embodiment, it provides identification and validation of discrete pairs of devices where there are other pairs of devices also trying to connect at the same time. It effectively reduces the risk of cross connections between these devices i.e. there no unintended pairs of devices which are connected or validated in such a case

Existing methods exist for validation of electronic device pairing for connectivity and exchange. However, the present disclosure offers certain technical advantages over these conventional methodologies. For example, the disclosed technology can validate and connect a pair of devices without them being in close proximity to one another. Another technical advantage offered is that the risk of cross connections is reduced

The disclosure also limits the interactions of the device with the users, does not require any complicated gestures or any verbal or written communication between the device users prior to the connection

According to the present disclosure, a connection can be initiated by a sequential, non-simultaneous pointing of the devices in two separate different directions without any physical contact between the devices. A valid connection is intended by both parties and the technology in the disclosure establishes a connection between the correct parties. The technology is able to correctly identify the pair of devices trying to connect with each other in a scenario where there are other pairs of devices also trying to connect to each other at the same time using the same process

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 provides a flowchart for validating a connection between the devices according a preferred embodiment of the present disclosure

FIG. 2 depicts initiating the process of connecting the devices using the technology of the present disclosure

FIG. 3 depicts the stage at which both devices are pointing towards each other

FIG. 4 shows the stage beginning the involvement of an inanimate object

FIG. 5 shows the stage at which both devices involve the inanimate object

FIG. 6 shows a preferred embodiment in which the devices have established direction vectors in three dimensional space

FIG. 7 show another embodiment involving perpendicular vectors

### DETAILED DESCRIPTION OF THE FIGURES

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures.

In addition, all logical units described and depicted in the figures include the software and/or hardware components required for the unit to function. Further, each unit may comprise within itself one or more components, which are implicitly understood. These components may be operatively coupled to each other and be configured to communicate with each other to perform the function of the said unit

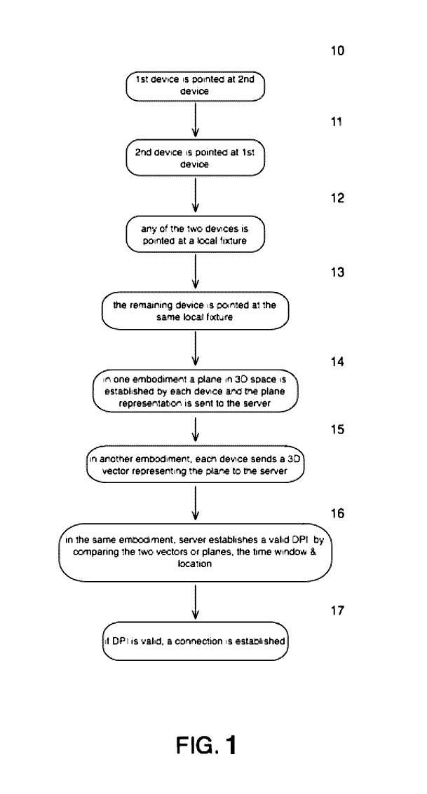

FIG. 1 depicts the process of establishing a connection between two devices according a preferred embodiment of the present disclosure. The process involves two users who are present at a location and are at some distance from each other. Either of the users can start the connection process. Devices that intend to connect to each other at first need to point to each other and then to a physical immobile fixture or object visible to users of both the devices. It does not matter which device initiates the first pointing and which device reciprocates

In a preferred embodiment, the intention to establish a connection is signalled by a request that is part of a message sent by a device to a server SR. The process starts at step 10 when the first user points his device at the second user to initiate the connection between their devices. This is followed by the next step 11 in which the second user follows the first user and points his device at the device of the first user. Next, in step 12, which can be initiated by any of the users, one of the users and points his device at any inanimate physical fixture at the location which in a preferred embodiment is a street lamp. This is followed by step 13, in which the other user follows this user and also points his device at the same fixture.

Next, in a preferred embodiment, in step 14, each of the devices has established their own direction vector in three dimensional space and therefore a plane in 3D space is established. Each of the devices then sends a plane representation of their direction vector to the server SR. In this first preferred embodiment, the direction vectors V1 and V2 are used to establish a plane M1 in 3D space by device D1. Vectors V3 and V4 are used to establish a plane M2 in 3D space by device D2. Both devices send their planar representations to the server SR and these are used by the server SR to validate the connection between these devices

In an alternate embodiment, in step 15, each device generates a vector perpendicular to their established direction vectors. Each of the devices sends their perpendicular vector representing the plane to the server SR. In this second embodiment, device D1 uses the direction vectors V1 and V2 to establish a third vector PV1 that is perpendicular to the vectors V1 and V2. Similarly device D2 uses the direction vectors V3 and V4 to establish a third vector PV2 that is perpendicular to the vectors V3 and V4. Both devices send representations of these perpendicular vectors PV1 and PV2 to the server SR and these are used by the server SR to validate the connection between these devices

Next, in step 16, the server SR initiates the process of validating the connection by comparing the received plane representations or perpendicular vectors from each device, along with other information such as the time window of establishment of the vectors or the planes as well as the location of the devices. If they match, then the server SR validates the connection and send an appropriate signal. The process completes then in the final step 17, when the connection establishes if a signal representation a match is received by the devices

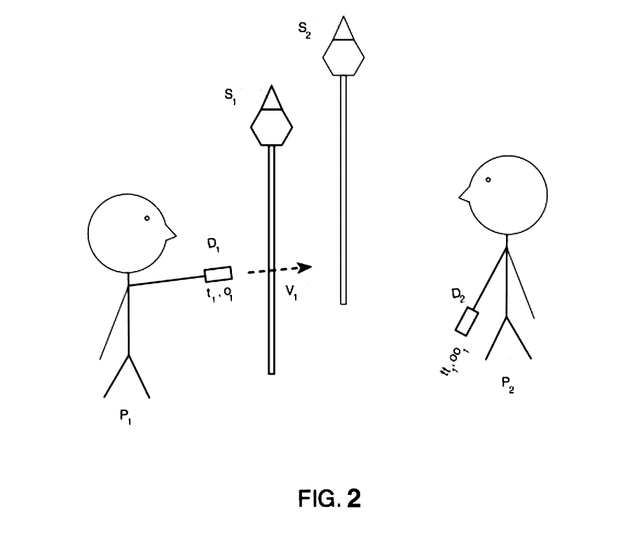

FIG. 2 depicts initiating the process of connecting the devices using the technology of the present disclosure. It shows two users P1 and P2 at a location at a distance from each other. P1 at first points his device D1 at user P2. At time t1, device D1 has an orientation o1 and device D2 has orientation oo1. User P1 then initiates the process of connecting the devices although either one of the 2 users can initiate the process of connecting their device with the other user's device. Device D1 now establishes its first 3D direction vector V1 based on orientation o1. This figure also shows two street lamps 51 and S2

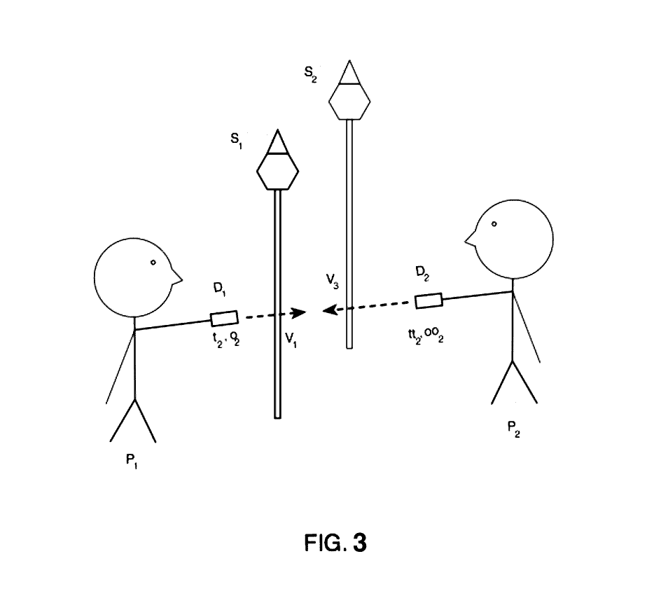

FIG. 3 depicts the stage at which both devices are pointing towards each other. It now shows the two users shown in FIG. 1 in which the second user P2 follows user P1 and points his device D2 at the first user's device D1. Device D1 still has the same orientation o1 as in FIG. 1 at time t2. However, since device D1 has been moved, it now has an orientation oo2 at time t2. But both devices are now pointing at each other. Now device D2 establishes its first 3D direction vector V3 based on orientation oo2. D1 already has his established first direction vector V1. This figure also shows two street lamps S1 and S2

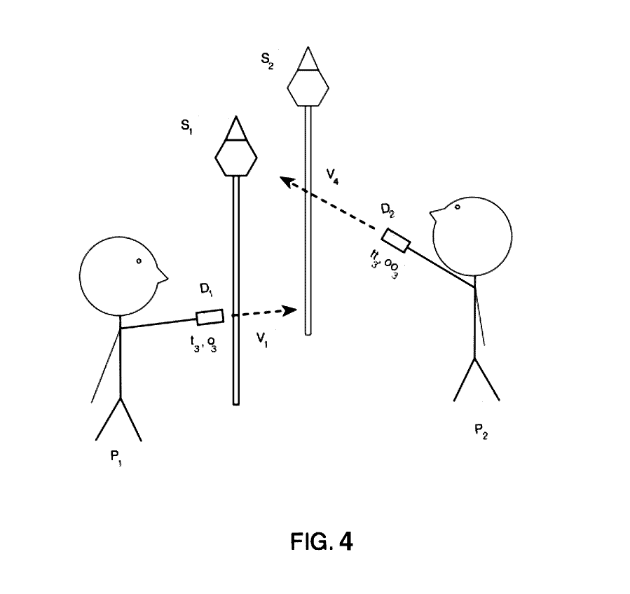

FIG. 4 shows the stage at which there is an involvement of an inanimate object. The next step can be initiated by any one of the two users. In this embodiment, the second user P2 takes the initiative and points his device D2 at any inanimate physical fixture at the location. In this embodiment, street lamp S1 is chosen for this purpose. Now, device D2 has a new orientation oo3 at time t3. User P1 meanwhile has not changed the orientation of his device D1 and has an established vector V1. Device D2 establishes its second direction vector V4 based on its orientation oo3. The orientation of device D1 is the same o1 at time t3. Street lamp S2 is shown for reference

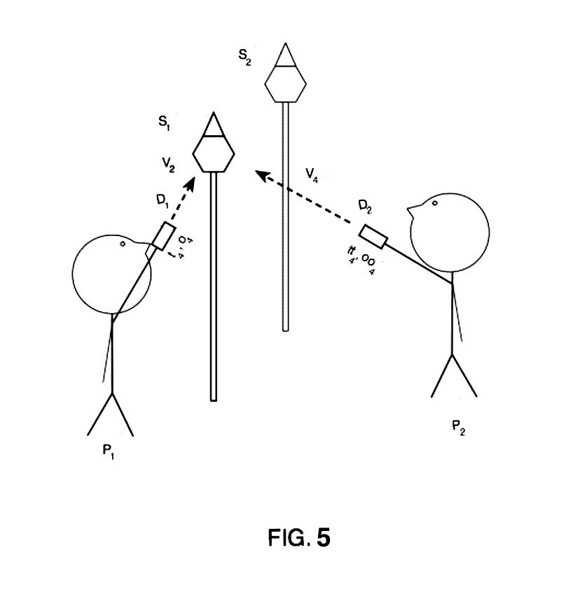

FIG. 5 shows the stage at which both devices involve the inanimate object. User P1 follows user P2 and also points his device D1 at the same fixture S1 that device D2 is pointing at. The orientation of device D1 is now o4 at time t4 and the orientation of device D2 is the same as before i.e. oo3 at time t4. Vector V2 is the second direction vector established by device D1 and vector V4 is the second direction vector established by device D2

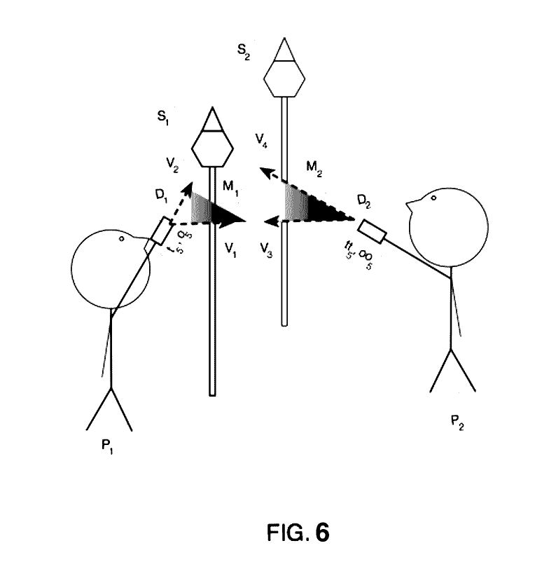

FIG. 6 shows a preferred embodiment in which the devices have established direction vectors in three dimensional space. In one embodiment, plane M1 is generated by device D1 using direction vectors V1 and V2 while plane M2 is generated by device D2 using direction vectors V3 and V4 in 3D space. The two users P1 and P2 point their devices D1 and D2 respectively at street lamp S1. Orientation of device D1 is o4 at time t5 and the orientation of device D2 is oo4 at time t5. Direction vectors V1 and V2 are the first and second direction vectors established by device D1 and direction vectors V3 and V4 are the first and second direction vectors established by device D2 in 3D space.

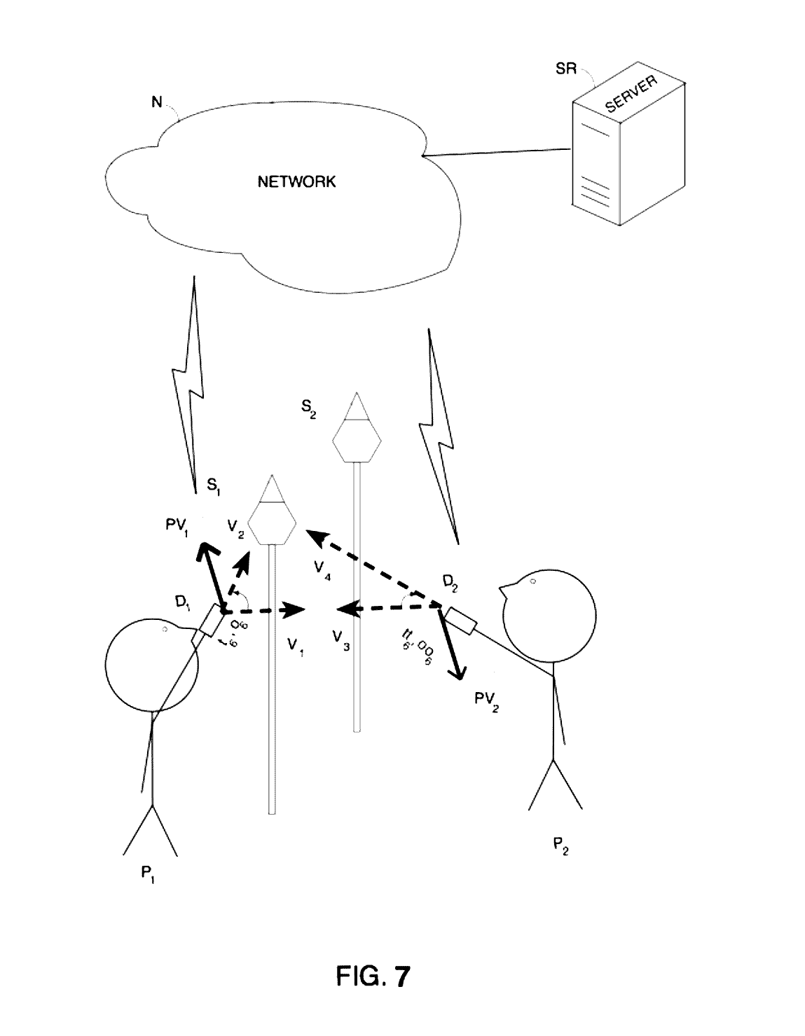

FIG. 7 show another embodiment involving perpendicular vectors. A vector PV1 is perpendicular to vectors V1 and V2 and is generated by device D1. Vector PV2 is perpendicular to vectors V3 and V4 and is generated by device D2. The orientation of device D1 is o5 at time t6 and the orientation of device D2 is oo5 at time t6. This is shown in FIG. 6. Both devices send their representations of the perpendicular vectors PV1 and PV2 to the server SR

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

Instructions may also be loaded onto a computer or other programmable data processing apparatus like a scanner/check scanner to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and schematic diagrams of FIGS. 1 to 3 illustrate the architecture, functionality, and operations of some embodiments of methods, systems, and computer program products for time related interaction of a user with a handheld device. In this regard, each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed exemplary embodiments of the invention. Although specific terms are employed, they are used in a generic and descriptive sense only and not for purposes of limitation, the scope of the invention being defined by the following claims.

We claim:

1. A method for uniquely identifying and validating discrete pairs of electronic devices intending to connect in order to exchange information, comprising the steps of:
a. detecting, at a first user device, a greeting event based at least in part on visual proximity to a second user device and on the orienting one axis on said first user device to point to a second user device, and,
b. orienting an axis on said second user device, similar to said axis on said first user device, to point to said first user device, wherein the said second device is at a location from where the said first user device is visible, and the said first user device is at a location from where the said second user device is visible, and both said user devices are within a predetermined geographical radius from each other, and,
c. subsequently orienting said axis on said first user device and said axis on said second user device to point to an object visible from the location of said first user device and said second user device, not attached to said first user device or said second user device,
d. receiving a first orientation vector from said first user device, and, receiving a second orientation vector from said second user device within a predetermined time from the time that the said first orientation vector was sent, whereby said first user device and said second user device will be identified and validated as a discrete pair of devices intending to connect in order to exchange information without being in close proximity to each other.

2. The method of claim 1 further comprising the steps of:
a. sending an “unmatched time” signal to the said first user device and the said second user device if either the said first orientation vector or the said second orientation vector is received after the predetermined time from the time that the said first orientation vector was sent, or,
b. sending an “unmatched vector” signal to the said first user device and the said second user device if the said first orientation vector is not aligned with the said second orientation vector within a predetermined degree of tolerance, whereby said first user device and said second user device will not be validated as a pair of devices intending to connect

3. The method of claim 1 wherein the said second user device and the said first user device are both within range of any wireless or wired connectivity node.

4. The method of claim 1, wherein detecting a greeting event comprises the steps of:
a. detecting that the first user device experiences a change in orientation of said first user device from a starting orientation of said first user device to an ending orientation of said first user device while said first user device is in visual proximity to said second user device; and
b. receiving a communication from said second user device, the received communication indicating that the second user device experienced a change in orientation of said second user device from a starting orientation of said second user device to and ending orientation of said second user device while said second user device is in visual proximity to said first user device.

5. The method of claim 4, wherein the orientation change consistent with execution of a greeting event by the user of said first user device comprises of generating a mathematical plane in three dimensional space that passes through a first orientation vector representing the starting orientation of said first user device and a second orientation vector representing the ending orientation of said first user device.

6. A portable electronic device that may be worn, comprising:
a. a gyroscope sensor operable to detect an orientation of the said portable electronic device;
b. a wireless communication interface operable to communicate with a server;
c. a storage subsystem configured to store data including a plurality of shareable data objects; and
d. a processing subsystem coupled to the gyroscope sensor, the wireless communication interface, and the storage subsystem, the pressing subsystem configured to:
detect, based at least in part on a signal from the wireless communication interface, that another electronic device is in proximity to the said portable electronic device;
detect, based at least in part on a signal from the gyroscope sensor, an occurrence of a greeting gesture while the other electronic device is in visual proximity to the said portable electronic device;
determine one or more items of context information in response to detecting the greeting event;
select, based at least in part on the one or more items of context information, a shareable data object from the plurality of shareable data objects; and
send via the wireless communication interface to the said server, the shareable data object to be available and retrieved by said other electronic device.

7. The said portable electronic device of claim 6 wherein the one or more items of context information include the vector representation of the mathematical plane previously described by the portable electronic device while in visual proximity to the other electronic device.

8. The portable electronic device of claim 6 wherein the processing subsystem is further configured such that detecting the occurrence of the greeting event includes receiving a communication from the other electronic device via the said server confirming that the other electronic device also detected the occurrence of the greeting event.

9. The portable electronic device of claim 6 wherein the portable electronic device can also be worn on a user's wrist.

10. The portable electronic device of claim 6 wherein the portable electronic device can also be worn on a user's fingers.

11. A method comprising the steps of:
a. detecting, at a first user device, a greeting event based at least in part on visual proximity to a second user device and an orientation change of said first user device and said second user device;
b. determining, by the first user device, context information for the greeting event;
c. selecting, by said first use device, a first data object to be sent to said second user device, the selection being based at least in part on the context information; and
d. sending, by said first user device, the first data object to a server.

12. The method of claim 11 further comprising, subsequently to sending the first data object to the server, sending, by said first user device, an approval message to the server, the approval message authorizing the server to release the said first data object to the said second user device.

13. The method of claim 11 further comprising the steps of:
receiving, by said first user device, at least one second information item from said second user device while said first electronic device is in visual proximity to said second user device;
storing, by said first user device, said second data object;

14. A method for discrete pair validation comprising the steps of:
a. receiving a said first vector orientation from said first user device,
b. receiving a said second vector orientation from said second user device,
c. the first user device and the second user device are within a radius predetermined on the first user device and on the said second user device, and,
d. periodically receiving orientation vectors from one or more other user devices, and,
e. if the first and second said orientation vectors are sent at the same time within a predetermined tolerance, and,
f. if the orientation vector of the first user device and the orientation vector of the second user device are aligned in three dimensional space within a predetermined tolerance, then sending a discrete pair validation signal to the said first user device and the said second user device.
